(19) United States
(12) Patent Application Publication
(10) Pub. No.: US 2026/0057532 A1
(43) Pub. Date: Feb. 26, 2026

(54) GENERATING IMAGES OF VIRTUALLY STAINED BIOLOGICAL SAMPLES

(71) Applicant: Verily Life Sciences LLC, South San Francisco, CA (US)

(72) Inventors: Andrew Homyk, South San Francisco, CA (US); Yang Wang, Mountain View, CA (US)

(73) Assignee: Verily Life Sciences LLC, South San Francisco, CA (US)

(21) Appl. No.: 19/102,553

(22) PCT Filed: Jul. 14, 2023
(86) PCT No.: PCT/US2023/070284

§ 371 Date: Feb. 10, 2025

Related U.S. Application Data
(60) Provisional application No. 63/396,864, filed on Aug. 10, 2022.

(51) Int. Cl. G06T 7/33; G06T 7/00

(52) U.S. Cl. CPC G06T 7/337; G06T 7/0012; G06T 2207/20081; G06T 2207/30024; G06T 2207/30168

(57) ABSTRACT

One example method for generating images of virtually stained biological samples includes receiving a first image pair comprising a first image of a biological sample and a second image of the biological sample, the first image captured using a first imaging technique and the biological sample being unstained, the second image captured using a second imaging technique different from the first imaging technique and the biological sample being stained; receiving a proposed alignment of the first image and the second image; generating alignment quality information corresponding to the first image pair, the alignment quality information indicating an alignment confidence of the first and second images; training a machine learning (“ML”) model, using the first image pair and the alignment quality information, to generate an output image of the biological sample having a virtual stain according to the second imaging technique from the first image; receiving, by the ML model, a first input image of a first biological sample captured using the first imaging technique, the first biological sample being unstained; and generating, by the ML model, a first output image according to the second imaging technique, the first output image comprising a virtually stained image of the first biological sample.

### CROSS-REFERENCE TO RELATED APPLICATIONS

This international application claims priority to U.S. Patent Application No. 63/396,864, filed on Aug. 10, 2022, the disclosure of which is herein incorporated by reference in its entirety for all purposes.

### FIELD

The present application relates to generating images of virtually stained biological samples from images of unstained biological samples.

### BACKGROUND

Interpretation of biological samples to determine the presence of cancer requires substantial training and experience with identifying features that may indicate cancer. Typically, a pathologist will receive a slide containing a slice of tissue and examine the tissue to identify features on the slide and determine whether those features likely indicate the presence of cancer, e.g., a tumor. In addition, the pathologist may also identify features, e.g., biomarkers, that may be used to diagnose a cancerous tumor, that may predict a risk for one or more types of cancer, or that may indicate a type of treatment that may be effective on a tumor. To aid in analyzing the slide, the biological sample may be stained using a suitable stain, such as a hematoxylin and eosin (“H&E”) stain, to enhance the visibility of certain cellular features within the sample. The stain can be applied to a slice of a biological sample, which can then be presented to a microscope for examination or to capture an image of the stained biological sample for later analysis.

### SUMMARY

Various examples are described for generating images of virtually stained biological samples. One example method includes receiving a first image pair comprising a first image of a biological sample and a second image of the biological sample, the first image captured using a first imaging technique and the biological sample being unstained, the second image captured using a second imaging technique different from the first imaging technique and the biological sample being stained; receiving a proposed alignment of the first image and the second image; generating alignment quality information corresponding to the first image pair, the alignment quality information indicating an alignment confidence of the first and second images; training a machine learning (“ML”) model, using the first image pair and the alignment quality information, to generate an output image of the biological sample having a virtual stain according to the second imaging technique from the first image; receiving, by the ML model, a first input image of a first biological sample captured using the first imaging technique, the first biological sample being unstained; and generating, by the ML model, a first output image according to the second imaging technique, the first output image comprising a virtually stained image of the first biological sample.

Another example method includes receiving an image of a biological sample captured using a first imaging technique, the biological sample being unstained in the image; providing the image to a trained ML model, the ML trained using (a) image pairs comprising a first image of a biological sample and a second image of the biological sample, the first image captured using a first imaging technique and the biological sample being unstained, the second image captured using a second imaging technique different from the first imaging technique and the biological sample being stained, and (b) alignment quality information corresponding to the image pairs, the alignment quality information indicating an alignment confidence of the first and second images of a respective image pair based on a proposed alignment of the first image and the second image; and generating, by the trained ML model, an output image according to a second imaging technique different from the first imaging technique, the output image comprising a virtually stained image of the biological sample.

One example system includes a non-transitory computer-readable medium; and one or more processors communicatively coupled to the non-transitory computer-readable medium and configured to execute processor-executable instructions stored in the non-transitory computer-readable medium to receive a first image pair comprising a first image of a biological sample and a second image of the biological sample, the first image captured using a first imaging technique and the biological sample being unstained, the second image captured using a second imaging technique different from the first imaging technique and the biological sample being stained; receive a proposed alignment of the first image and the second image; generate alignment quality information corresponding to the first image pair, the alignment quality information indicating an alignment confidence of the first and second images; train a machine learning (“ML”) model, using the first image pair and the alignment quality information, to generate an output image of the biological sample having a virtual stain according to the second imaging technique from the first image; receive, by the ML model, a first input image of a first biological sample captured using the first imaging technique, the first biological sample being unstained; and generate, by the ML model, a first output image according to the second imaging technique, the first output image comprising a virtually stained image of the first biological sample.

One example non-transitory computer-readable medium includes processor-executable instructions configured to cause one or more processors to receive a first image pair comprising a first image of a biological sample and a second image of the biological sample, the first image captured using a first imaging technique and the biological sample being unstained, the second image captured using a second imaging technique different from the first imaging technique and the biological sample being stained; receive a proposed alignment of the first image and the second image; generate alignment quality information corresponding to the first image pair, the alignment quality information indicating an alignment confidence of the first and second images: train a machine learning (“ML”) model, using the first image pair and the alignment quality information, to generate an output image of the biological sample having a virtual stain according to the second imaging technique from the first image; receive, by the ML model, a first input image of a first biological sample captured using the first imaging technique, the first biological sample being unstained; and generate, by the ML model, a first output image according to the second imaging technique, the first output image comprising a virtually stained image of the first biological sample.

These illustrative examples are mentioned not to limit or define the scope of this disclosure, but rather to provide examples to aid understanding thereof. Illustrative examples are discussed in the Detailed Description, which provides further description. Advantages offered by various examples may be further understood by examining this specification.

### BRIEF DESCRIPTION OF THE DRAWINGS

The accompanying drawings, which are incorporated into and constitute a part of this specification, illustrate one or more certain examples and, together with the description of the example, serve to explain the principles and implementations of the certain examples.

FIGS. 1-2 show example systems for generating images of virtually stained biological samples;

FIGS. 3-7 show example virtual software stainer software for generating images of virtually stained biological samples;

FIG. 8 shows an example method for generating images of virtually stained biological samples; and

FIG. 9 shows a computing device suitable for use with systems and methods for generating images of virtually stained biological samples.

### DETAILED DESCRIPTION

Examples are described herein in the context of generating images of virtually stained biological samples. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another.

A biological sample may be taken from a patient to determine various information about a potential health issue with a patient, such as whether cancer is present, tumor status, the presence of one or more biomarkers, etc. To do so, after a sample is taken, it may be prepared and positioned on a slide for image capture. A captured image of the sample may then be reviewed by a pathologist to identify various features present in the sample. To assist this process, the sample is typically stained, such as using an H&E stain or an immunohistochemistry (“IHC”) stain. However, staining a sample may present difficulties in locations where stains may not be readily available or may be prohibitively expensive.

To address these issues, a machine learning (“ML”) model may be trained to receive an image of an unstained biological sample and apply a “virtual” stain to the image. In other words, the ML applies color information to pixels within the image of the unstained biological sample to simulate the appearance of the biological sample had a particular stain been applied. For example, the ML model may apply a virtual H&E stain.

To train the ML model to generate a virtually stained biological sample from an image of an unstained sample, the ML model is presented with a training set of image pairs of the biological samples. In each pair of images, one image is of a sample after being stained and the other image is of the unstained sample. For each image pair in the training set, the ML model generates a virtually stained image from the unstained image and learns based on the discrepancies between the virtually stained image and the image of the stained sample.

A difficulty with such a training process is ensuring that the two images in each image pair are aligned with each other. The images are aligned when a particular pixel in the image of the unstained sample and the corresponding pixel in the image of the stained sample both represent the same location within the sample. If the images are not aligned, the ML model may accurately virtually stain the image; however, it will appear to be incorrectly stained when compared with the image of the stained sample because features at a particular location in the image of the stained sample will be at a different location in the virtually stained image.

Aligning the two images in an image pair may be performed based on features present within the two images. However, while the images as a whole may be aligned, portions of the image may still appear mis-aligned. For example, portions of the biological sample may be stretched, torn, folded, or otherwise deformed in one image, but not the other. For example, after capturing an image of the unstained sample, the sample may be stained and re-imaged. Handling of the sample during the staining process or preparing the stained sample for imaging may result in physical damage to portions of the image. Thus, alignment between these portions of the two images may not be possible. Image pairs that include such apparent internal misalignments can reduce the quality of the training data provided to the ML model, which can, in turn, reduce the efficacy of the ML model in generating virtually stained images.

To help address this issue, a training process for a ML model analyzes internal alignment between image pairs to identify patches that may include such distorted or damaged tissue. The images are first aligned using a suitable alignment process. After alignment, the images are each divided into a number of corresponding images patches, which are then used to determine a patch-wise alignment. After determining alignments for each patch, patches which appear to be significantly mis-aligned can be marked as misaligned patches and ignored or otherwise deemphasized during the training process for the ML model. Thus, the ML model can still operate on the image pair, but patches of the images that have been marked as mis-aligned will have a lesser impact on the training process.

By performing the internal patch-wise alignment determinations, an ML model can be trained on image pairs from a set of training images despite defects in one image or the other in a particular image pair. Further, because the internal alignment process is used, image pairs that might otherwise provide poor quality training or that might be discarded can still be used to train the ML model.

This illustrative example is given to introduce the reader to the general subject matter discussed herein and the disclosure is not limited to this example. The following sections describe various additional non-limiting examples and examples of generating images of virtually stained biological samples.

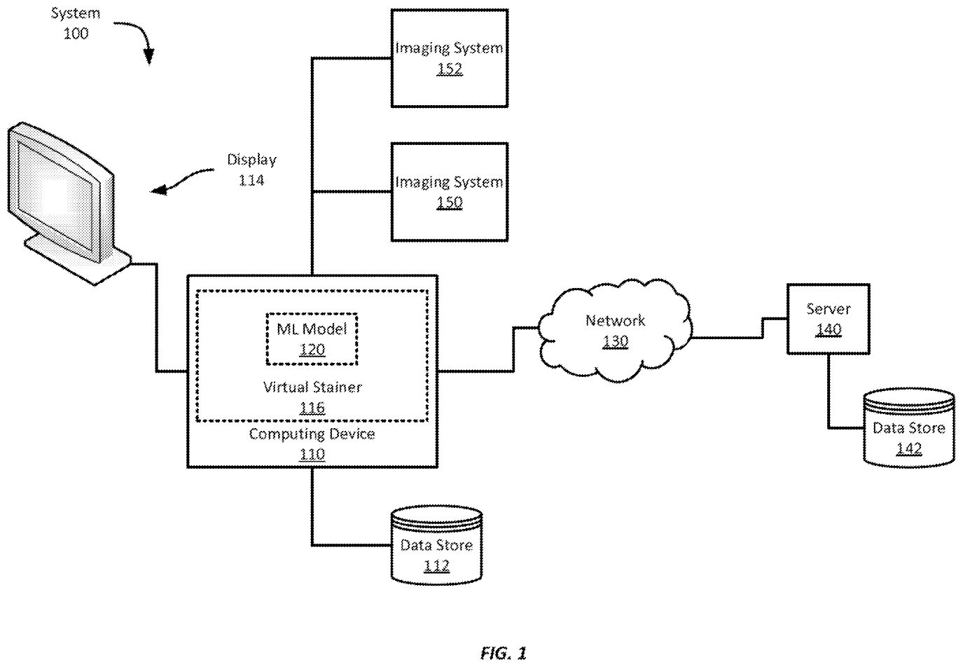

Referring now to FIG. 1, FIG. 1 shows an example system 100 for generating images of virtually stained biological samples. The system 100 includes two imaging systems 150-152 that are connected to a computing device 110. The computing device 110 has virtual stainer software 116, which includes a ML model 120, stored in memory. The computing device 110 is connected to a display 114, a local data store 112, and to a remote server 140 via one or more communication networks 130. The remote server 140 is, in turn, connected to its own data store 142.

The imaging systems 150-152 each include a microscope and camera to capture images of biological samples. Imaging system 150 in this example is a conventional pathology imaging system that captures digital images of biological samples, stained or unstained, using broad-spectrum visible light. In contrast, imaging system 152 includes an autofluorescence (“AF”) microscope system which projects laser light onto biological samples, which excites various molecules or compounds within the sample. The light emitted by the excited molecules or compounds is captured by the AF microscope system as a digital image having pixels with large numbers of frequency components, i.e., significantly more than conventional red-green-blue (“RGB”) color channels used in visible light images, each corresponding to light emitted by the various molecules or compounds present in the sample.

Because the AF microscope generates such a large amount of information per pixel, the AF images are generally not interpretable by humans. However, they contain vast amounts of information that can help identify the presence of various cellular features. Thus, AF images can be of significant importance in diagnosing medical conditions. To assist doctors in interpreting AF images, a virtual stainer with a trained ML model can use an AF image to generate a virtually stained image with conventional color channels, such as RGB or hue-saturation-value (“HSV”) channels, that can be interpreted by a person.

The imaging systems 150-152 capture images of the stained and unstained biological sample. In this example, the AF microscope captures an image of the unstained biological sample, while the conventional pathology imaging system captures an image of the stained biological sample. The imaging systems 150-152 provide their captured images to the computing system 110. The computing system 110 thus receives digital images from each of the imaging systems 150-152 corresponding to a particular biological sample and trains the ML model 120 to apply a virtual stain to an image of an unstained biological sample.

In one scenario, a biological sample will be prepared for imaging within the conventional imaging system 150, such as by obtaining a thin slice of tissue taken from a patient, staining it with a suitable stain (e.g., H&E or IHC), and positioning it on a slide, which is inserted into the imaging system 150. The imaging system 150 then captures an image of the stained sample (referred to as the “stained image”) and provides it to the computing device 110. The stained biological sample may then be washed of the stain and positioned on a slide, which is then inserted into the AF imaging system 152. The AF imaging system 152 captures an AF image of the unstained biological sample (referred to as the “unstained image”) and provides it to the computing device 110.

Some workflows may involve capturing the AF image first before staining the biological sample and imaging it with the conventional imaging system 150 because it may eliminate the step of washing the stain from the sample. But any suitable approach to capturing stained and unstained images of the same biological sample may be employed.

And while in this example, the imaging systems 150-152 are connected to the computing device 110, such an arrangement is not needed. For example, an example system may omit one or both of the imaging systems 150-152 and the computing device 110 could instead obtain stained and AF images from its data store 112 or from the remote server 140. Similarly, while the virtual staining is performed at the computing device 110, in some examples, stained and AF images may be provided to the remote server 140, which may execute virtual stainer software 116, including a suitable ML model, e.g., ML model 120.

After receiving the captured images, whether from imaging systems 150-152 or a data store 112, the virtual stainer software 116 pre-processes the images before aligning them. In this example, the virtual stainer software 116 includes image preprocessing functionality that modifies or transforms images into a form that improves the one or more image processing processes applied to the image. The preprocessing can include (for example) stain normalization, intensity normalization, color normalization (e.g., RGB values of pixels), affine transformations, and/or one or more image enhancements (e.g., blurring, sharpening, increasing or decreasing a resolution, and/or data perturbation).

Stain normalization, for example, modifies the image properties of a stained image according to different stain compositions or techniques (e.g., H&E, virtual staining, fluorescent, etc.) in which a stain compositions or technique may correspond to images with different variations in pixel color (e.g., in the red, green, blue color space) or intensities. Stain normalizing the image(s) can include (for example) normalizing pixel intensity values and/or one or more RGB values using a target statistic. The target statistic can be calculated using the pixel intensity one or more images (e.g., the mean, median, and/or mode of a set of images corresponding to different stain compositions and/or techniques). For example, an image of a sample stained with H&E stain may be normalized such that a mean, median, maximum, or mode intensity matches a mean, median, maximum or mode intensity of the unstained image. In addition, the virtual stainer software aligns the images of the image pair to each other, which may include scaling one or both of the images so they have a same scale. Properties of the image as a result of preprocessing can be stored or appended to the image via annotations or metadata.

Initially, the virtual stainer software 116 may include an untrained ML model 120, which must be trained to generate accurate virtually stained images from images of unstained biological samples. To do so, the virtual stainer software 116 receives image pairs, whether from the imaging systems 150-152 or the data store 112, that include an unstained image and a stained image of the same biological sample with a suitable stain applied. For example, if the ML model is being trained to generate virtually H&E-stained images, the stained image is of a biological sample with an H&E stain. Further, the stained image may include one or more labels corresponding to features present within the image, which may be used to train the ML model based on the virtually stained image that is output by the ML model.

The image pairs are pre-processed as discussed above and aligned. However, before presenting the image pairs to the ML model 120 as training inputs, the virtual stainer software 116 first performs patch-wise alignment analysis between the two images. The virtual stainer software 116 generates a set of patches for each aligned image. The patches are generated in pairs between the two images so that each patch in one image corresponds to a patch in the other image. The sizes of the patch may be any suitable size, such as 32×32, 64×64, or 128×128 pixels, but are the same size between the two images.

After generating the patches, the virtual stainer software 116 determines patch-wise alignment information for each pair of patches. In this example, the virtual stainer software 116 computes an alignment score for each pair of patches, such as based on the quality of alignment of features detected in the two images. If features within the two images align exactly, or within a single pixel, the virtual stainer software 116 may assign a high score, e.g., 100, to the two patches. However, if the features are significantly mis-aligned, e.g., by 20 pixels or more, the virtual stainer software 116 may assign a low score, e.g., 0, to the two patches. Less severe mis-alignments may be assigned intermediate scores according to a scoring curve. The scoring curve may be linear from 0 to 20 pixels of mis-alignment corresponding to scores from 0 to 100. Or it may be non-linear, with small mis-alignments, e.g., 0-3 pixels, being assigned scores between 85-100, while larger mis-alignments quickly result in low scores. For example, a misalignment of 4 pixels may correspond to a score of 65, a misalignment of 5 pixels may correspond to a score of 40, etc. Still any suitable scoring mechanism may be used based on a quality of an alignment between corresponding image patches. Other approaches to assessing patch-wise alignment quality may be used as well.

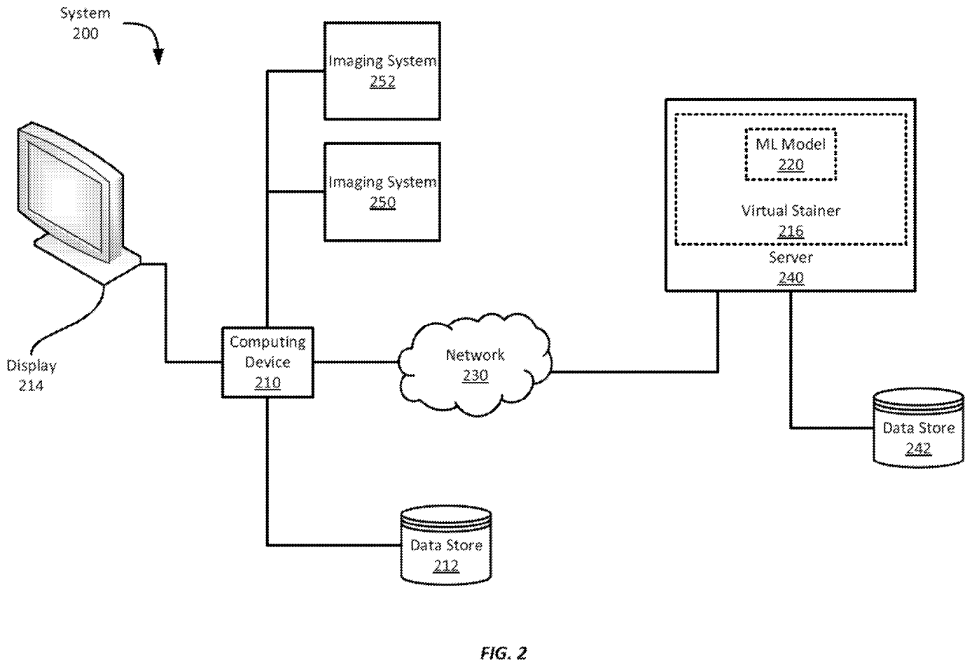

Referring now to FIG. 2, FIG. 2 shows another example system 200 for generating images of virtually stained biological samples. In this example, the system 200 includes components similar to those shown in the system 100 of FIG. 1. In particular, the system 200 includes a computing device 210 with a display 214 and a local data store 212. Two imaging systems 250-252 are connected to the computing device 210. The computing device 210 is connected to a remote server 240 via one or more communication networks 240. The remote server 240 in this example includes virtual stainer software 216, which includes an ML model 220, stored in memory.

In operation, the computing device 210 receives AF and stained images from the imaging systems 250-252 or a data store 212, 242. It then provides those images to the server 240, which trains its ML model 220 to generate virtually stained images, as will be discussed in more detailed below. Alternatively, once the ML model 220 is trained, the server 240 can execute the virtual stainer software 216 to generate virtually stained images from unstained images. It then provides the virtually stained image to the computing device 210, which can display any identified abnormal cells on the display 214.

Such an example system 200 may provide advantages in that it may allow a medical center to invest in imaging equipment, but employ a service provider to generate virtually stained images, rather than requiring the medical center to host its own virtual stainer software 116. This can enable smaller medical centers, or medical centers serving remote populations, to provide high quality diagnostic services without requiring them to take on the expense of obtaining or training their own virtual staining software 116.

It should be appreciated that while the systems 100, 200 shown in FIGS. 1 and 2 include two different imaging systems 150-152, 250-252 as discussed above, examples that have access to virtual stainer software 116, 216 that include a trained ML model may not need to capture images of both unstained and stained biological samples. Instead, a suitable system may include only an AF imaging system, which can provide an AF image to virtual stainer software 116, 216 to generate a virtually stained image based on the AF image.

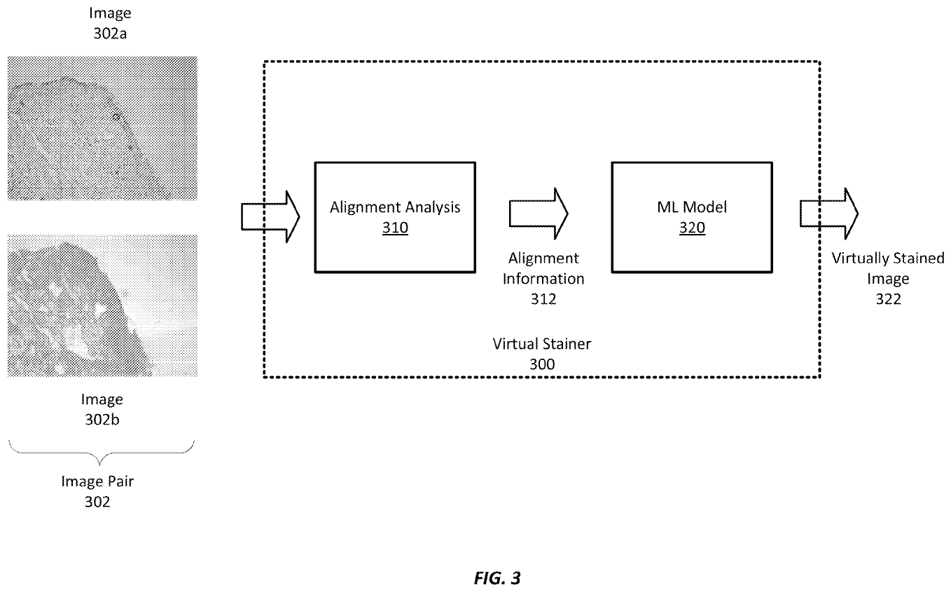

Referring now to FIG. 3, FIG. 3 shows an example virtual stainer 300 that performs patch-wise alignment quality assessment when training its ML model 320. In this example, an image pair 302 that includes an AF image 302a and a stained image 302b have been pre-processed and aligned. The image pair 302 is presented to the virtual stainer 300 as an input training image pair 302. The virtual stainer 300 inputs the image pair into the alignment analysis system 310, which performs a patch-wise alignment assessment between the images 302a-b.

As discussed above, corresponding image patches are generated for each image. The entirety of both images in this example are divided into image patch pairs, though in some examples, image patches are only generated for portions of the image containing tissue. The image patch pairs are then compared to determine the alignment between the image patches within the respective pair of image patches. Any suitable approach to determining patch-wise alignment may be employed. For example, a brute-force per-pixel comparison between the two images may be performed. A brute-force approach may compare corresponding pixel values assuming perfect alignment and compute differences, or squares of differences, between corresponding pixel values. The image patches may then be iteratively offset from each other by one or more pixels in different directions and pixel values differences for each candidate offset may be computed. The offset presenting the best alignment score, based on the computed pixel differences, may then be used to determine an alignment quality score, such as discussed above with respect to FIG. 1.

Other approaches may be employed instead. For example, the system may perform a structural similarity (“SSIM”) assessment or mean SSIM (“MSSIM”) of corresponding image patches. Alternatively, the system may assess an alignment quality using mutual information or normalized cross-correlation. Still other approaches, including convolutional techniques, may be used in some examples.

In addition, techniques may be used to recognize damage or other defects within the biological sample. For example, the alignment analysis system 310 may detect the presence of folds or tears in the biological sample in one (or both) of the images 302a-b.

In this example, the alignment analysis system 310 generates alignment information that includes patch-wise alignment information. The alignment information may include a binary identification of whether individual patches are well-aligned or poorly aligned, e.g., their alignment quality is meets or is below a threshold quality. In some examples, the alignment information may identify an alignment quality. As discussed above, alignment quality may be a numerical value, such as a pixel offset between two patches, or it may include structural similarity information or mutual information or normalized cross-correlation values. Still other example may generate patch-wise alignment information according to any suitable technique.

The alignment information 312 and the image pair 302 are then provided to the ML model 320. The ML model 320 generates a virtually stained image 322 and, during its training phase, computes a loss function on the virtually stained image 322 and updates its model.

Because the virtual stainer 300 employs the alignment analysis system 310 it is able to better train the ML model 320 during a training phase because, while the images 302a-b in the image pair 302 may be aligned at the image level, internal misalignment may occur in different regions due to handling of the physical biological samples between capturing the unstained and stained images. This can occur due to stretching, folding, tearing, or other damage to portions of the biological sample as a result of handling the sample. The alignment analysis system 310 can identify these regions of misalignment and provide that information to the ML model to further improve the quality of input data during the training process.

Moreover, while the virtual stainer software 300 is illustrated as including the alignment analysis system 310, it should be appreciated that it may be a separate software component from the virtual stainer software 300. Such an embodiment may allow the alignment analysis system 310 to be used during a training process for the ML model 320 and then disabled, removed, or bypassed during operation of the virtual stainer software 300 with a trained ML model 320. Moreover, the alignment analysis system 310 may be installed on a separate computing device from the virtual stainer software 300. For example, aligned image pairs may be processed by an alignment analysis system 310 and the results may then be stored, such as in a data store 112, 142, 212, 242. At a later time, the aligned image pairs and corresponding alignment information may be retrieved and used to train a ML model 320 for a virtual stainer software 300.

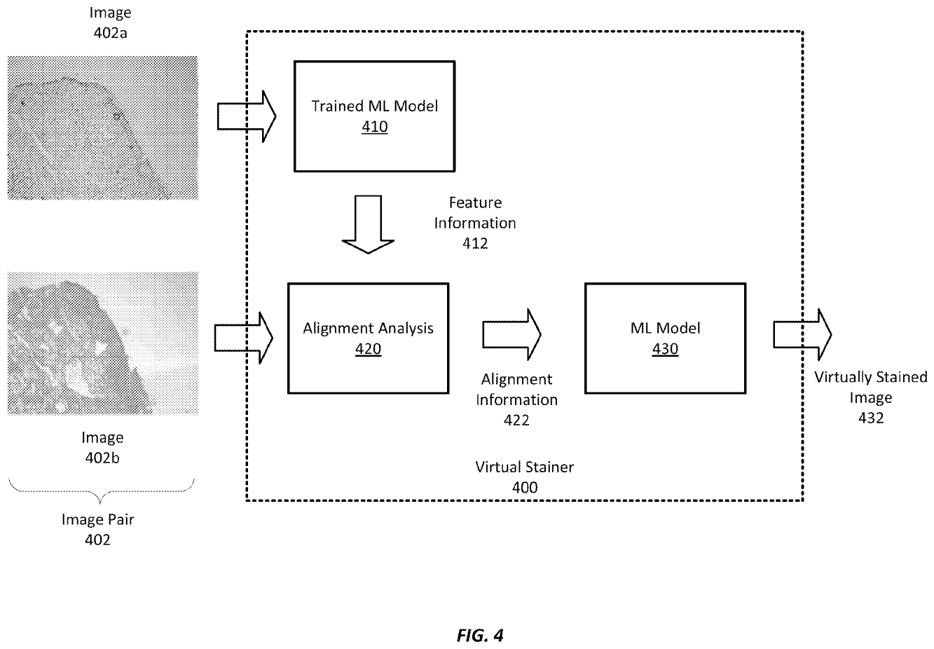

Referring now to FIG. 4, FIG. 4 shows another example of virtual stainer software 400 for generating images of virtually stained biological samples. In this example, the virtual stainer software 400, like the example shown in FIG. 3, includes an alignment analysis system 420 and an ML model 430 to generate virtually stained images 432. In addition, the virtual stainer software 400 employs a trained ML model 410 that can identify feature information 412 in the unstained image 402a. The feature information 412 may then be provided to the alignment analysis system 420 along with the image pair 402.

After receiving the image pair 402 and the feature information 412, the alignment analysis system 420 performs patch-wise alignment assessment as discussed above with respect to FIG. 3, but also uses feature information 412 associated with the unstained image 402a to assess alignment with labeled features within the stained image 402b. For example, structural similarity, mutual information, or normalized cross-correlation may be used to assess patch-level alignment. In addition, feature-level alignment may also be assessed for features present in particular patches based on the feature information 412 and training labels associated with the stained image 402b. Using two different techniques to perform patch-level alignment assessment may provide more accurate alignment information 422 than only using one of these techniques. Though it should be appreciated that the alignment analysis system 420 in some examples may only employ the feature information 412 from the trained ML model 410 to perform patch-level alignment assessment. Alignment information is then generated generally as discussed above with respect to FIG. 3.

The alignment information 422 generated by the alignment analysis system 420 is provided to the ML model 430 undergoing training along with the image pair 402. Training based on the image pair 402 and the alignment information 422 is performed generally as discussed above with respect to FIG. 3.

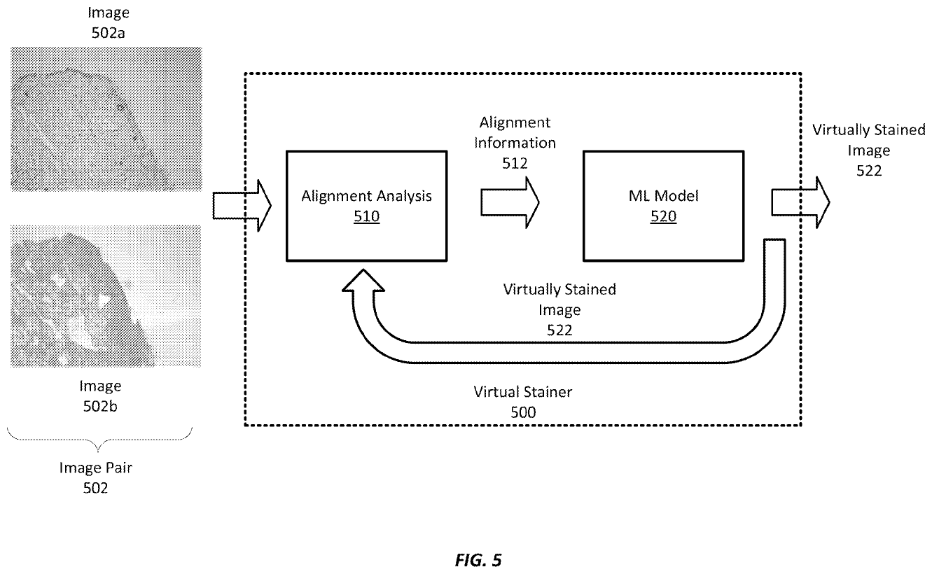

Referring now to FIG. 5, FIG. 5 shows another example of virtual stainer software 500 for generating images of virtually stained biological samples. In this example, the virtual stainer software 500, like the example shown in FIG. 3, includes an alignment analysis system 510 and an ML model 520 to generate virtually stained images 522.

As with the example shown in FIG. 3, the virtual stainer software 500 receives an aligned image pair 502 to train its ML model 520. The aligned image pair 502 is provided to the alignment analysis system 510, which performs alignment analysis on the two images as discussed above. However, the unstained image 502a is also provided to the ML model 520, which generates a virtually stained image 522. The virtually stained image 522 is then provided to the alignment analysis system 510, which performs the alignment analysis based on an alignment between the virtually stained image 522 and the stained image 502b and between the virtually stained image 522 and the stained image 502a or the unstained image 502b. For example, the alignment analysis system 510 may perform an alignment assessment between the stained image 502b and the virtually stained image 522, including based on any features identified in the virtually stained image 522 and labels associated with the stained image 502b. Further, because the virtually stained image is based on the unstained image, such alignment between the two stained images may directly inform the alignment between the unstained image 502a and the stained image 502b. The alignment information 512 and the image pair 502 may then be provided to the ML model 520 for training generally as discussed above.

Such a technique may improve the accuracy of the alignment analysis system 510 by using additional information generated by the ML model 520. And while the ML model is still operating in a training mode, the output data may still be of sufficiently high quality to enable improved patch-wise alignment assessment.

It should be further appreciated that the examples shown in FIGS. 4 and 5 may be combined to provide both information from the virtually stained image 522 and feature information from a trained ML model 410 to the alignment analysis system 420 to provide alignment information 422, 512 to the ML model 430, 520 for training.

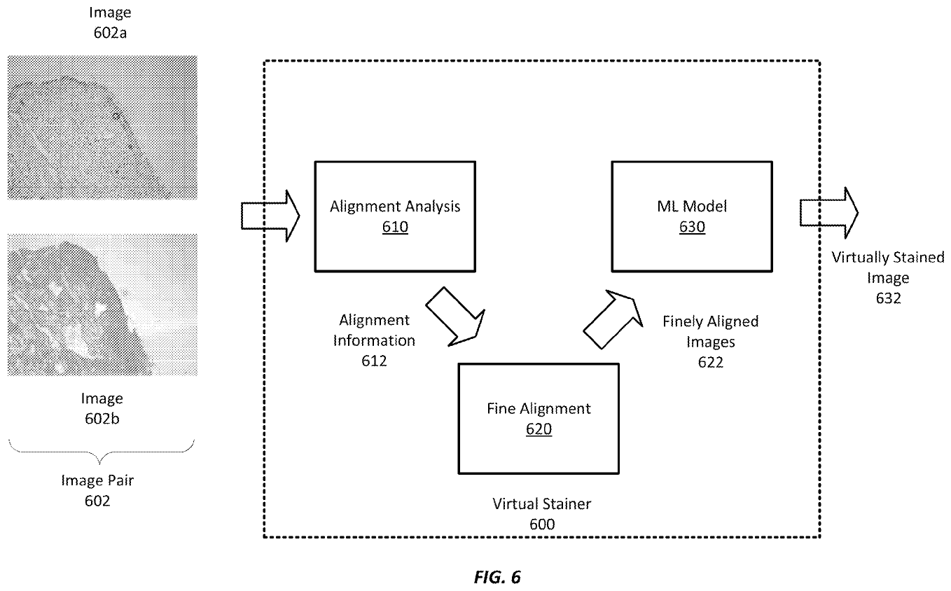

Referring now to FIG. 6, FIG. 6 shows another example virtual stainer 600 that employs an alignment analysis system 610 to train the ML model 630. In addition, the virtual stainer 600 includes a fine alignment system 620 that performs additional image alignment based on the output of the alignment analysis system 610. The alignment analysis system 610 may include any of the alignment analysis systems 310, 410, 520 discussed above with respect to FIGS. 3-5. Moreover, the additional ML model 410 from the example in FIG. 4 or the use of a virtually stained image 522 as discussed above with respect to FIG. 5 may be employed with different examples of the virtual stainer software 600.

After generating alignment information 612, the virtual stainer software 600 executes the fine alignment system 620 to perform further alignment between identified patches in the image pair 602. The fine alignment system 620 performs fine alignment based on the received alignment information 612. Suitable alignment information may identify determined offsets between corresponding patches within the image pair using the techniques discussed above. The offsets may then be applied by the fine alignment system 620. In some examples, corresponding patches may be sent to the alignment assessment from the fine alignment system 620 for further alignment assessment.

It should be appreciated that in some examples, fine alignment may not be possible for some patches. For example, tears, folds, or other damage to the biological sample represented in one image may not be present in the other image, which may prevent alignment between patches corresponding to such damage or defects.

After the images have been finely aligned, they are provided to the ML model 630 for training, generally as discussed above. It should be appreciated that any approach to providing alignment information 612 discussed above with respect to FIGS. 3-5 may be employed with the system 600 shown in FIG. 6.

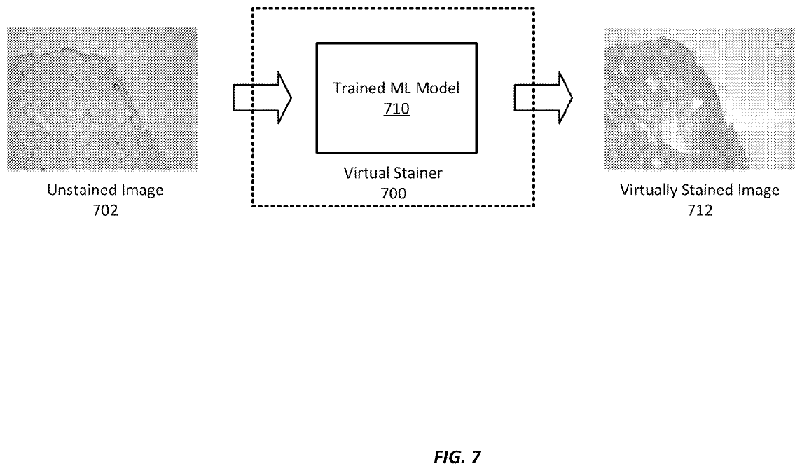

Referring now to FIG. 7, FIG. 7 illustrates an example virtual stainer software 700 after its ML model 710 has been trained according to the techniques discussed above. The virtual stainer software 700 may then receive an unstained image 702, such as an AF image, as input and generate a virtually stained image 712. As discussed above with respect to FIGS. 1-2, virtual stainer software 700 may be operated on a local computing device 110, 210 or on a remote computing device 140, 240, such as in a cloud computing environment, to provide virtually stained images based on received unstained images.

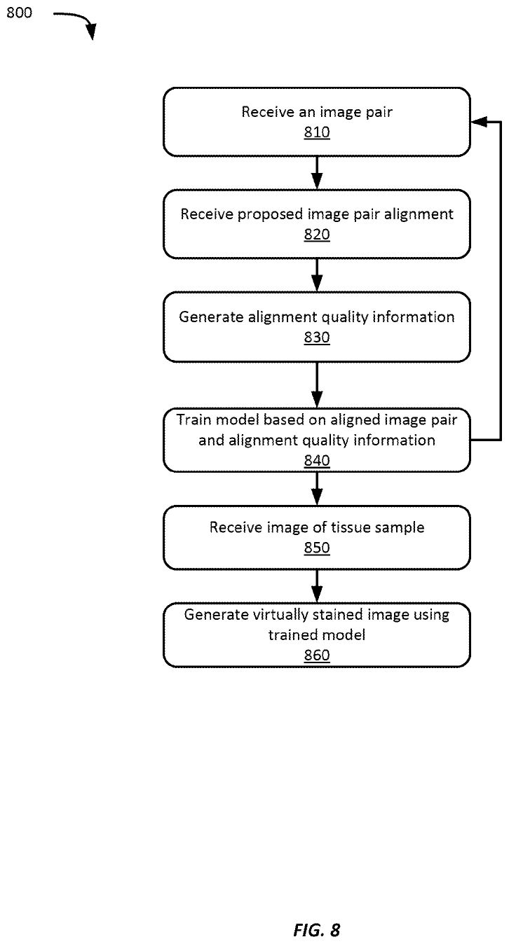

Referring now to FIG. 8, FIG. 8 shows an example method 800 for generating images of virtually stained biological samples. This example method 800 will be discussed with respect to the example system shown in FIG. 1 and the virtual stainer software 300 shown in FIG. 3; however it should be appreciated that any suitable system according to this disclosure may be employed, including the system 200 shown in FIG. 2 and the example virtual stainer software 400-600 shown in FIGS. 4-6.

At block 810, the computing device 110 receives an image pair 302. In this example, the computing device 110 receives the image pair from the imaging systems 150-152. However, in some examples the computing device 110 may receive the image pair 302 from a local data store 112 or a remote data store 142.

At block 820, the virtual stainer software 300 receives a proposed alignment of a first image 302a of the image pair 302 and the second image 302b of the image pair 302. For example, the computing device 110 may execute image alignment software to align the two images. Any suitable image alignment software may be employed to provide the proposed alignment of the image pair 302. In this example, the proposed alignment includes edits to one or both images, such as zooming, rotating, shifting, cropping, etc. to provide the image pair. It should be appreciated that the proposed alignment may be represented by the image pair itself. For example, the computing device 110 may receive the image pair 302, which may then be processed by alignment software to generate an aligned image pair, which provides the proposed alignment. Thus, in some examples blocks 810 and 820 may be combined into a single block.

At block 830, the virtual stainer software 300 generates alignment quality information generally as discussed above with respect to FIG. 3. In this example, the alignment quality information provides scores, such as on a scale from 1-100 or as a real number between 0-1, for corresponding patches established within the images 302a-b. However, other examples may provide other alignment quality information, such as offset information.

In some examples, alignment quality information may be generated based on additional information. For example, as discussed above with respect to FIG. 4, a trained ML model 410 may be used to generate feature information 412 based on an unstained image. The feature information 412 may be provided to the alignment analysis system 420 as discussed above with respect to FIG. 4.

As discussed above with respect to FIG. 5, the ML model 520 may first generate a virtually stained image 522 based on the unstained image 502a. The virtually stained image 522 may then be provided to the alignment analysis system 510, which may use the image pair 502 and the virtually stained image 522 to generate alignment information 512.

At block 840, the virtual stainer 300 trains the ML model 320 using the image pair and the alignment quality information. In this example, the virtual stainer software 300 omits one or more image patches having an alignment score below a threshold value and only provides image patches having alignment scores that meet the threshold value. In some examples, however, only some of the image patches with inadequate alignment scores may be omitted. For example, the virtual stainer software 300 may provide 25% or 33% of patches having alignment scores below a threshold value, while omitting the remaining 75% or 67%, respectively. In some examples, the virtual stainer software 300 may determine a number of patches with inadequate alignment scores to retain based on a ratio of patches with inadequate alignment to patches with adequate alignment. For example, the fewer patches in an image with inadequate alignment scores relative to patches with adequate alignment scores, the larger number of the patches with inadequate alignment scores may be used.

Alternatively, patches with alignment scores below a threshold score may have a weight applied to them, such as based on the difference between the alignment score and the threshold score. The weight may be used by the ML model 320, such as by the loss function, to adjust the impact of the of the poorly aligned patches on the training process, while still using the patches for training.

Further, in some examples, alignment information 612 may first be provided to a fine alignment system 620, which may perform further fine alignment on one or more image patches. The finely aligned images may then be provided to the ML model 630 as a part of the training process.

After performing block 840, the method 800 may return to block 810 to iterate through a set of training image pairs to train the ML model 320. If the ML model 320 has been trained, the method may instead begin at block 850.

At block 850, the virtual stainer software 300 receives an unstained AF image 302a, such as from an image capture system 152. However, in some examples, the virtual stainer software 300 may receive the unstained AF image 302a from a data store 112, 142, 212, 242.

At block 860, the virtual stainer software 300 generates a virtually stained image 322 using the ML model 320 trained according to blocks 810-840 discussed above.

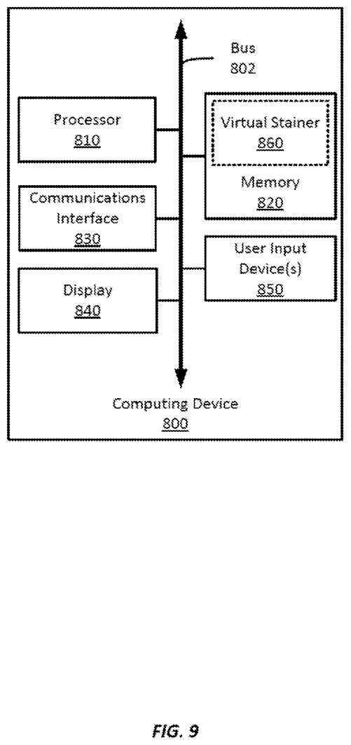

Referring now to FIG. 9, FIG. 9 shows an example computing device 900 suitable for use in example systems or methods for generating images of virtually stained biological samples according to this disclosure. The example computing device 900 includes a processor 910 which is in communication with the memory 920 and other components of the computing device 900 using one or more communications buses 902. The processor 910 is configured to execute processor-executable instructions stored in the memory 920 to perform one or more methods for generating images of virtually stained biological samples according to different examples, such as part or all of the example method 800 described above with respect to FIG. 8. In this example, the memory 920 includes virtual stainer software 960, such as the example system shown in FIGS. 3-7. In addition, the computing device 900 also includes one or more user input devices 950, such as a keyboard, mouse, touchscreen, microphone, etc., to accept user input; however, in some examples, the computing device 900 may lack such user input devices, such as remote servers or cloud servers. The computing device 900 also includes a display 940 to provide visual output to a user.

The computing device 900 also includes a communications interface 940. In some examples, the communications interface 930 may enable communications using one or more networks, including a local area network (“LAN”); wide area network (“WAN”), such as the Internet; metropolitan area network (“MAN”); point-to-point or peer-to-peer connection; etc. Communication with other devices may be accomplished using any suitable networking protocol. For example, one suitable networking protocol may include the Internet Protocol (“IP”), Transmission Control Protocol (“TCP”), User Datagram Protocol (“UDP”), or combinations thereof, such as TCP/IP or UDP/IP.

While some examples of methods and systems herein are described in terms of software executing on various machines, the methods and systems may also be implemented as specifically-configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, that may store processor-executable instructions that, when executed by the processor, can cause the processor to perform methods according to this disclosure as carried out, or assisted, by a processor. Examples of non-transitory computer-readable medium may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone: C alone; A and B only; A and C only; B and C only; and A and B and C.

1. A method comprising:
receiving a first image pair comprising a first image of a biological sample and a second image of the biological sample, the first image captured using a first imaging technique and the biological sample being unstained in the first image, the second image captured using a second imaging technique different from the first imaging technique and the biological sample being stained in the second image;
receiving a proposed alignment of the first image and the second image;
generating alignment quality information corresponding to the first image pair, the alignment quality information indicating an alignment confidence of the first and second images; and
training a machine learning (“ML”) model, using the first image pair and the alignment quality information, to generate an output image of the biological sample having a virtual stain according to the second imaging technique from the first image.

2. The method of claim 1, wherein generating the alignment quality information comprises:
determining an offset between one or more pixels in the first image and one or more corresponding pixels in the second image; and
determining whether the offset exceeds a threshold offset.

3. The method of claim 1, wherein generating the alignment quality information comprises:
identifying corresponding image patches within the first image or the second image;
determining an alignment quality between respective corresponding image patches; and
outputting, for each image patch, the respective alignment quality.

4. The method of claim 3, wherein determining the alignment quality comprises performing a structured similarity analysis between corresponding image patches.

5. (canceled)

6. (canceled)

7. The method of claim 3, further comprising ignoring corresponding image patches having the respective alignment quality below a threshold when training the ML model.

8. The method of claim 3, further comprising assigning weights to corresponding image patches in the first and second images and adjusting respective weights of corresponding image patches having the respective alignment quality below a threshold when training the ML model.

9-20. (canceled)

21. A method comprising:
receiving an image of a biological sample captured using a first imaging technique, the biological sample being unstained in the image;
providing the image to a trained ML model, the ML trained using (a) image pairs comprising a first image of a biological sample and a second image of the biological sample, the first image captured using a first imaging technique and the biological sample being unstained, the second image captured using a second imaging technique different from the first imaging technique and the biological sample being stained, and (b) alignment quality information corresponding to the image pairs, the alignment quality information indicating an alignment confidence of the first and second images of a respective image pair based on a proposed alignment of the first image and the second image; and
generating, by the trained ML model, an output image according to a second imaging technique different from the first imaging technique, the output image comprising a virtually stained image of the biological sample.

22. The method of claim 21, wherein the first imaging technique comprises AF imaging.

23. The method of claim 21, wherein generating the alignment quality information comprises:
determining an offset between one or more pixels in the first image and one or more corresponding pixels in the second image of the respective image pair; and
determining whether the offset exceeds a threshold offset.

24. The method of claim 21, wherein the alignment quality information is generated based on identifying corresponding image patches within the first image or the second image of the respective image pair; determining an alignment quality between respective corresponding image patches; and outputting, for each image patch, the respective alignment quality.

25. The method of claim 24, wherein the alignment quality is determined based on performing a structured similarity analysis between corresponding image patches.

26. The method of claim 24, wherein the alignment quality is determined based on performing a mutual information analysis between corresponding image patches.

27. The method of claim 24, wherein the alignment quality is determined based on performing normalized cross-correlation between corresponding image patches.

28. (canceled)

29. (canceled)

30. A system comprising:
a non-transitory computer-readable medium; and
one or more processors communicatively coupled to the non-transitory computer-readable medium and configured to execute processor-executable instructions stored in the non-transitory computer-readable medium to:
receive an image of a biological sample captured using a first imaging technique, the biological sample being unstained in the image;
provide the image to a trained ML model, the ML trained using (a) image pairs comprising a first image of a biological sample and a second image of the biological sample, the first image captured using a first imaging technique and the biological sample being unstained, the second image captured using a second imaging technique different from the first imaging technique and the biological sample being stained, and (b) alignment quality information corresponding to the image pairs, the alignment quality information indicating an alignment confidence of the first and second images of a respective image pair based on a proposed alignment of the first image and the second image; and
generate, by the trained ML model, an output image according to a second imaging technique different from the first imaging technique, the output image comprising a virtually stained image of the biological sample.

31. The system of claim 30, wherein the first imaging technique comprises AF imaging.

32. The system of claim 30, wherein generating the alignment quality information comprises:
determining an offset between one or more pixels in the first image and one or more corresponding pixels in the second image of the respective image pair; and
determining whether the offset exceeds a threshold offset.

33. The system of claim 30, wherein the alignment quality information is generated based on identifying corresponding image patches within the first image or the second image of the respective image pair; determining an alignment quality between respective corresponding image patches; and outputting, for each image patch, the respective alignment quality.

34. The system of claim 33, wherein the alignment quality is determined based on performing a structured similarity analysis between corresponding image patches.

35. The system of claim 33, wherein the alignment quality is determined based on performing a mutual information analysis between corresponding image patches.

36. The system of claim 33, wherein the alignment quality is determined based on performing normalized cross-correlation between corresponding image patches.
